(19) United States
(12) Patent Application Publication
(10) Pub. No.: US 2013/0274987 A1
(43) Pub. Date: Oct. 17, 2013

(54) LUGGAGE CASE AND LUGGAGE CASE MOVING METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 13/848,029

(22) Filed: Mar. 20, 2013

(30) Foreign Application Priority Data
Apr. 13, 2012 (TW) 101113374

(51) Int. Cl. G05D 1/02

(52) U.S. Cl. CPC G05D 1/0251
USPC 701/28

(57) ABSTRACT

An exemplary luggage case moving method includes obtaining an image captured by a camera. The image includes a distance information indicating distances between the camera and objects captured by the camera. The method then creates a 3D scene model. Next, the method determines whether the target person appears in the created 3D scene model according to stored 3D models of target persons. The method then determines a target person minimum region in the obtained image, generates an actual minimum region, and compares the size of the actual minimum region with the size of a stored minimum region sample to determine the moving direction of the target person. The method next controls the driving unit to drive the luggage case to move toward the determined moving direction. A related luggage case is also provided.

### BACKGROUND

1. Technical Field

The present disclosure relates to luggage cases, and particularly, to a luggage case capable of automatically moving with a target person and a luggage case moving method.

2. Description of Related Art

Luggage cases are usually lugged behind by a person. However, the luggage case may be heavy and may cause fatigue to the person lugging it. Thus, a luggage case capable of automatically moving with the person may be desirable.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram illustrating a luggage case, in accordance with an exemplary embodiment.

FIG. 2 is a schematic view of the luggage case of the FIG. 1.

FIG. 3 is a schematic view showing that an actual minimum region is compared with a minimum region sample by a direction determining module of the luggage case of FIG. 1.

FIG. 4 is a schematic view showing that a center of the actual minimum region is compared with a center of the minimum region sample by an angle determining module of the luggage case of FIG. 1.

FIG. 5 is a schematic view illustrating how to determine the rotation direction and the rotation angle of the luggage case of FIG. 1.

FIG. 6 is a flowchart of a luggage case moving method, in accordance with an exemplary embodiment.

### DETAILED DESCRIPTION

The embodiments of the present disclosure are described with reference to the accompanying drawings.

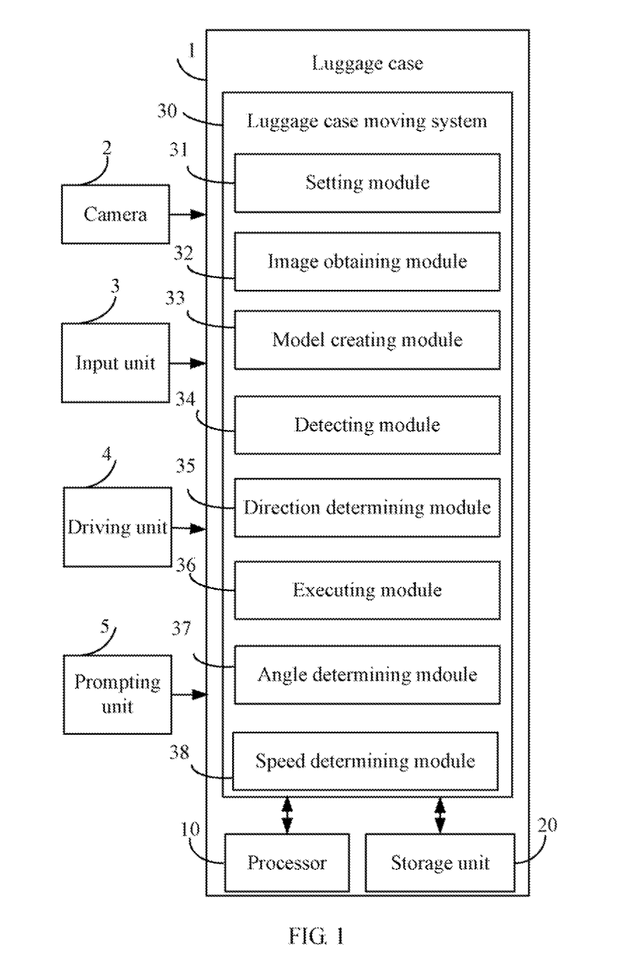

FIG. 1 is a block diagram illustrating a luggage case 1 that can automatically move with a target person. The luggage case 1 is connected to a camera 2, an input unit 3, and a driving unit 4. The luggage case 1 can analyze an image captured by the camera 2, determine whether a target person appears in the image, determine the moving direction of the target person, and further control the driving unit 4 to drive the luggage case 1 to move toward the determined moving direction of the target person.

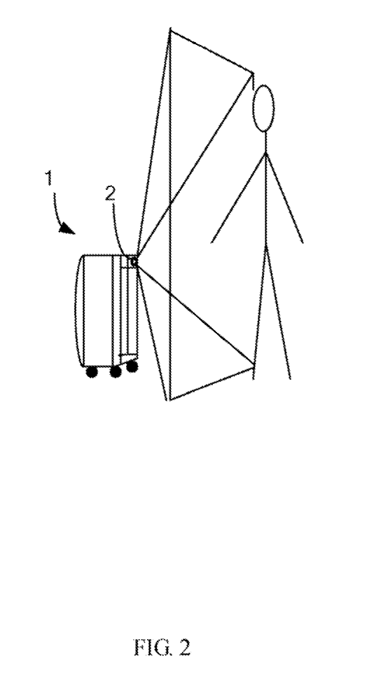

Referring to FIG. 2, each captured image shot by the camera 2 includes distance information indicating the distance between the camera 2 and any object in the field of view of the camera 2. The camera 2 is arranged on the luggage case 1.

The luggage case 1 includes a processor 10, a storage unit 20, and a luggage case moving system 30. In the embodiment, the luggage case moving system 30 includes a setting module 31, an image obtaining module 32, a model creating module 33, a detecting module 34, a direction determining module 35, and an executing module 36. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

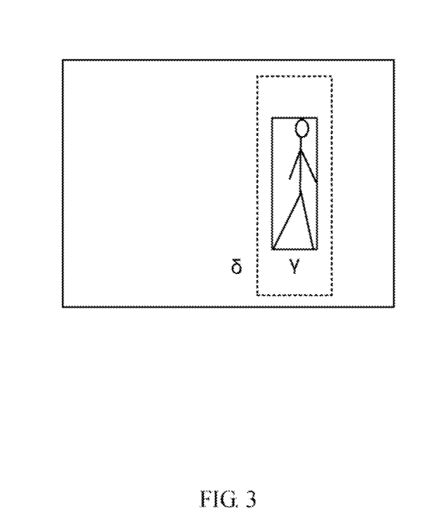

The storage unit 20 further stores a number of three-dimensional (3D) models of target persons and a distance between the luggage case 1 and the target person. Each 3D model of target person has a number of characteristic features. The 3D models of target persons may be created based on a number of images of target persons pre-collected by the camera 2 and the distances between the camera 2 and the person recorded in the pre-collected images of target persons. The distance relation between the luggage case 1 and the target person is pre-set through the setting module 31, and can be varied according to need. The setting module 31 is configured to obtain a sample of a target person image captured by the camera 2 in response to an operation on the input unit 3, determine a minimum region in the sample of the target person image to include the whole target person, generate a minimum region sample according to the determined minimum region in the sample of the target person image, and store the sample of the target person image which includes the minimum region sample in the storage unit 20. The size of the target person minimum region can indicate the relationship of the distance between the luggage case 1 and the target person. That is, when the size of the target person minimum region decreases, the distance between the luggage case 1 and the target person increases, when the size of the target person minimum region increases, the distance between the luggage case 1 and the target person decreases. Before the setting module 31 obtains the sample of the target person image, the luggage case 1 is placed in a position where the distance between the luggage case 1 and the target person is a preset distance. In the embodiment, the shape of the minimum region is rectangle. Of course, the shape of the target person minimum region can be other shapes, such as square. For example, in FIG. 3, the minimum region sample is represented by the dotted lines enclosing the letter 6.

The image obtaining module 32 is configured to obtain an image captured by the camera 2.

The model creating module 33 is configured to create a 3D scene model according to the image captured by the camera 2 and the distance between the camera 2 and any object in the field of view of the camera 2.

The detecting module 34 is configured to determine whether the target person appears in the created 3D scene model. In detail, the detecting module 34 is configured to extract data from the 3D scene model corresponding to the shape of the one or more objects appearing in the created 3D scene model, and compare each of the extracted data from the 3D scene model with characteristic features of each of the 3D target person models, to determine whether the target person appears in the created 3D scene model. If a piece of the extracted data from the created 3D scene model matches the characteristic features of any one of the 3D target person models, the detecting module 34 is configured to determine that the target person appears in the created 3D scene model. If none of the extracted data from the 3D scene model match any characteristic feature of any one of the 3D models of target persons, the detecting module 34 is configured to determine that no target person appears in the created 3D scene model.

When the target person appears in the created 3D scene model, the direction determining module 35 is configured to determine a target person minimum region in the obtained image to includes the whole target person and generate an actual minimum region according to the determined target person minimum region in the obtained image. For example, in FIG. 3, the actual minimum region is represented by the actual lines enclosing the letter γ. The direction determining module 35 is configured to compare the size of the actual minimum region with the size of the minimum region sample to determine the moving direction of the target person. In detail, when the direction determining module 35 determines that the size of the actual minimum region is less than the size of the minimum region sample, the direction determining module 35 determines that the moving direction of the target person relation to the luggage case 1 is forward. When the direction determining module 35 determines that the size of the actual minimum region is equal to the size of the minimum region sample, the direction determining module 35 determines that the target person relation to the luggage case 1 is still. When the direction determining module 35 determines that the size of the actual minimum region is greater than the size of the minimum region sample, the direction determining module 35 determines that the moving direction of the target person relation to the luggage case 1 is backward.

The executing module 36 is configured to control the driving unit 4 to drive the luggage case 1 to move toward the moving direction determined by the direction determining module 35, thus the luggage case 1 can automatically move with the moving of the target person without being dragged by the target person.

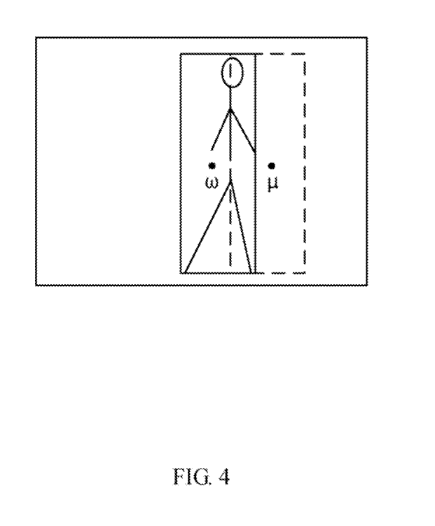

In the embodiment, the storage unit 20 further stores a position relation between the luggage case 1 and the target person, and a ratio of the image size of the object in the image captured by the camera 2 to the real-life size of the object when the distance between the object and the camera 2 is the preset value. The setting module 31 is further configured to determine a center of the minimum region sample and store the sample of the target person image including the center of the minimum region sample in the storage unit 20. The position of the center of the minimum region sample can indicate the relationship of the position between the luggage case 1 and the target person. Before the setting module 31 obtains the sample of the target person image, the luggage case 1 is also placed in a position where the position between the luggage case 1 and the target person is the preset position. For example, in FIG. 4, the center of the minimum region sample is labeled as the letter μ.

The luggage case moving system 30 further includes an angle determining module 37. The angle determining module 37 is configured to determine a center of the actual minimum region when the target person appears in the created 3D scene model. For example, in FIG. 4, the center of the actual minimum region is labeled as the letter ω. The angle determining module 37 is further configured to compare the determined center of the actual minimum region with the determined center of the minimum region sample when the difference between the difference between a first distance and a second distance is in a preset range, to determine a rotation direction and a rotation angle according to the ratio of the image size of the object in the image captured by the camera 2 to the real-life size of the object when the distance between the object and the camera 2 is the preset value. The first distance is the distance between the determined center of the actual minimum region and the camera 2. The second distance is the distance between the determined center of the minimum region sample and the camera 2.

In detail, when the difference between the first distance and the second distance is in a preset range, the angle determining module 37 is configured to align the sample of the target person image and the obtained image, and consider that the determined center of the actual minimum region and the determined center of the minimum region sample are in a same image. The angle determining module 37 is configured to establish a two-dimensional Cartesian coordinate system in the image, determine a set of coordinates of the center of the actual minimum region and a set of coordinates of the center of the minimum region sample in the same image to determine the virtual distance in the image between the center of the actual minimum region and the center of the minimum region sample. The angle determining module 37 is configured to determine the actual distance between the center of the actual minimum region and the center of the minimum region sample according to the stored ratio of the image size of the object in the image captured by the camera 2 to the real-life size of the actual object and the determined virtual distance in the image. A first side formed by the center of the actual minimum region and the center of the minimum region sample, a second side formed by the center of the actual minimum region and the camera 2, and a third side formed by the center of the minimum region sample are all connected to form a triangle. The angle determining module 37 is configured to determine the rotation direction and the rotation angle of the luggage case 1 according to the formula: cos θ=(a²+b²−c²)/2ab, wherein a represents the actual distance between the center of the actual minimum region and the center of the minimum region sample, b represents the distance between the center of the actual minimum region and the camera 2, and c represents the distance between the center of the minimum region sample and the camera 2.

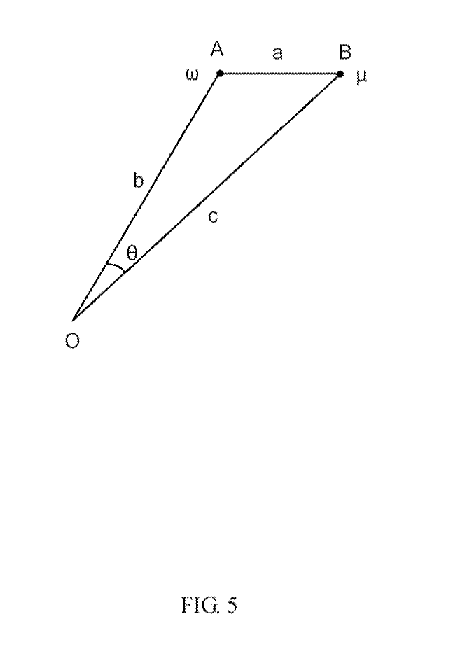

For example, in FIG. 5, the center of the actual minimum region ω and the center of the minimum region sample μ are considered to be in the same image, the center of the actual minimum region ω is on the right side of the center of the minimum region sample μ in the same image, the virtual distance between the center of the actual minimum region and the center of the minimum region sample is 0.9 cm, and the ratio of the image size of the object in the image captured by the camera 2 to the real-life size of the actual object is 1:100, thus the angle determining module 37 determines the actual distance a between the center of the actual minimum region ω and the center of the minimum region sample μ is 0.9 m. When the distance b between the center of the actual minimum region ω and the camera O is 0.9 m and the distance c between the center of the minimum region sample μ and the camera O is 0.9 m, the angle determining module 37 determines the rotation direction of the luggage case 1 is right and the rotation angle of the luggage case 1 is 60 degrees.

The executing module 36 is further configured to drive the driving unit 4 to rotate toward the determined rotation direction and rotate with the determined angle. Thus, although the walking path of the target person is curved, the luggage case 1 can automatically move with the target person, and the position relation between the luggage case 1 and the user are still the preset position.

In the embodiment, the storage unit 20 stores a shooting speed of the camera 2. The luggage case moving system 30 further includes a speed determining module 38. In the initial, the default moving speed of the luggage case 1 is a preset speed V₀.

The image obtaining module 32 is further configured to obtain a preset number of successive images captured by the camera 2 every a preset time period.

The model creating module 33 is further configured to create successive 3D scene models according to the preset number of successive images captured by the camera 2, and the distances between the camera 2 and any object in the field of view of the camera 2.

The detecting module 34 is further configured to determine whether the target person appears in the created successive 3D scene models. In detail, the detecting module 34 is configured to extract data from each created successive 3D scene model, the data corresponding to the shape of the one or more objects appearing in the created 3D scene model, and compare each of the extracted data from each created successive 3D scene model with characteristic features of each of the 3D models of target persons, to determine whether the target person appears in the created successive 3D scene models. If a piece of the extracted data from each successive 3D scene model matches the characteristic features of any one of the 3D models of target persons, the detecting module 34 is configured to determine that the target person do appear in the created successive 3D scene models. Otherwise, the detecting module 34 is configured to determine that the target person does not appear in the created successive 3D scene models.

The speed determining module 38 is configured to select any two created 3D scene models from the created successive 3D scene models, determine the shortest distance between the camera 2 and the target person included in each of the two selected 3D scene models, and determine the moved distance by the target person relation to the luggage case 1 in the two selected 3D scene models is the value of the difference (the subtraction) of the two determined shortest distance between the camera 2 and the target person in each of the two selected 3D scene models. The speed determining module 38 is further configured to determine the number of 3D scene models between the determined two created 3D scene models, divide the shooting speed of the camera 2 from the determined number of 3D scene models to determine a moving time passing while the target person moves the determined moved distance by the target person relation to the luggage case 1, and further determine the moving direction and moving speed of the target person relation to the luggage case 1 according to the formula: V=S/T, wherein V represents the moving speed of the target person relation to the luggage case 1; S represents the determined moved distance by the target person relation to the luggage case 1; and T represents the determined moving time. If the value of the moving speed of the target person relation to the luggage case 1 is a negative value, the speed determining module 38 determines that the moving direction of the target person relation to the luggage case 1 is toward the luggage case 1. If the value of the moving speed of the target person relation to the luggage case 1 is a positive value, the speed determining module 38 determines that the moving direction of the target person relation to the luggage case 1 is absent from the luggage case 1.

The speed determining module 38 is further configured to determine the moving speed of the luggage case 1 according to the moving direction and the moving speed of the target person relation to the luggage case 1, and the moving speed of the luggage case 1. In detail, when the moving direction of the target person relation to the luggage case 1 is absent from the luggage case 1, the speed determining module 38 determines that the moving speed of the luggage case 1 is equal to the determined moving speed of the target person relation to the luggage case 1 adding the default moving speed of the luggage case 1. When the moving direction of the target person relation to the luggage case 1 is toward the luggage case 1, the speed determining module 38 determines that the moving speed of the luggage case 1 is equal to the default moving speed of the luggage case 1 subtracting the determined moving speed of the target person relation to the luggage case 1. When the moving direction of the target person relation to the luggage case 1 is still, the speed determining module 38 determines that the moving speed of the luggage case 1 is equal to the default moving speed of the luggage case 1.

The executing module 36 is further configured to control the driving unit 4 to drive the luggage case 1 to move with the determined moving speed of the luggage case 1. Thus, the moving speed of the luggage case 1 is the same as the moving speed of the target person. This not only prevents the moving speed of the luggage case 1 relation to the target person from being too quick and cause the person to be harmed by the luggage case 1, but also prevents the moving speed of the luggage case 1 relation to the target person from being too slow to cause the target person to lose sight of the luggage case 1.

In the embodiment, the luggage case 1 is further connected to a prompting unit 5. When the detecting module 34 determines that the target person does not appear in the created 3D scene model, the executing module 36 is further configured to control the prompting unit 5 to prompt the target person, which prevents the luggage case 1 from being stolen.

In the embodiment, when the distance between the center of the actual minimum region and the camera 2 is greater than a preset distance, the executing module 36 is further to control the prompting unit 5 to prompt the target person to take care of the luggage case 1.

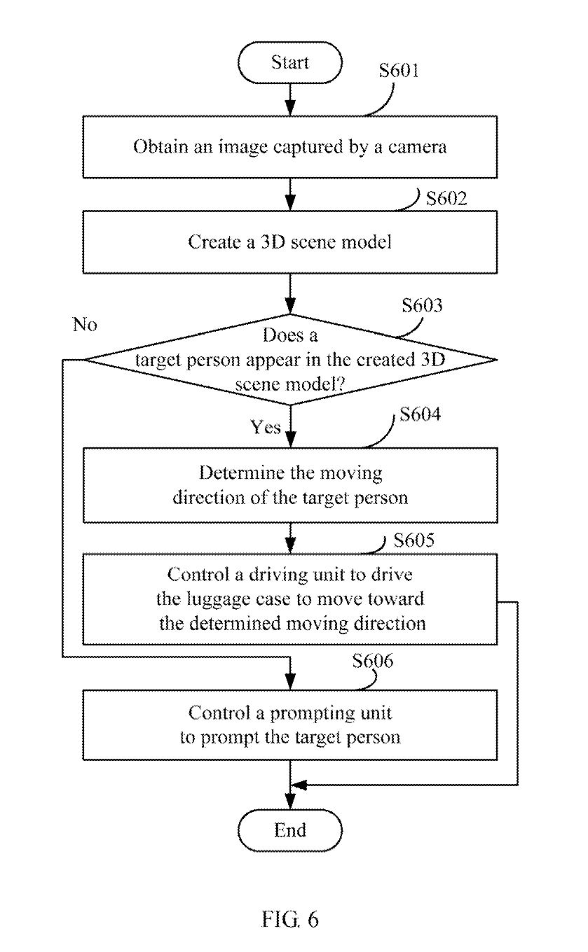

FIG. 6 shows a flowchart of a luggage case moving method in accordance with an exemplary embodiment.

In step S601, the image obtaining module 32 obtains an image captured by a camera 2.

In step S602, the model creating module 33 creates a 3D scene model according to the image captured by the camera 2 and the distance between the camera 2 and any object in the field of view of the camera 2.

In step S603, the detecting module 34 determines whether the target person appears in the created 3D scene model. If the target person appears in the created 3D scene model, the procedure goes to step S604. If the target person does not appear in the created 3D scene model, the procedure goes to step S606. In detail, the detecting module 34 extracts data from the 3D scene model corresponding to the shape of the one or more objects appearing in the created 3D scene model, and compares each of the extracted data from the 3D scene model with characteristic features of each of the 3D target person models, to determine whether the target person appears in the created 3D scene model. If a piece of the extracted data from the created 3D scene model matches the characteristic features of any one of the 3D target person models, the detecting module 34 determines that the target person appears in the created 3D scene model. If none of the extracted data from the 3D scene model match any characteristic feature of any one of the 3D models of target persons, the detecting module 34 determines that no target person appears in the created 3D scene model.

In step S604, the direction determining module 35 determines a target person minimum region in the obtained image to include the whole target person, generates an actual minimum region according to the determined target person minimum region in the obtained image, compares the size of the actual minimum region with the size of the minimum region sample to determine the moving direction of the target person. In detail, when the direction determining module 35 determines that the size of the actual minimum region is less than the size of the minimum region sample, the direction determining module 35 determines that the moving direction of the target person relation to the luggage case 1 is forward. When the direction determining module 35 determines that the size of the actual minimum region is equal to the size of the minimum region sample, the direction determining module 35 determines that the target person relation to the luggage case 1 is still. When the direction determining module 35 determines that the size of the actual minimum region is greater than the size of the minimum region sample, the direction determining module 35 determines that the moving direction of the target person relation to the luggage case 1 is backward.

In step S605, the executing module 36 controls the driving unit 4 to drive the luggage case 1 to move toward the determined moving direction.

In step S606, the executing module 36 controls the prompting unit 5 to prompt the target person, which prevents the luggage case 1 from being stolen.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. A luggage case comprising:
a storage unit;
a processor;
one or more programs stored in the storage unit, executable by the processor, the one or more programs comprising:
an image obtaining module operable to obtain an image captured by a camera, the image comprising a distance information indicating distances between the camera and objects captured by the camera;
a model creating module operable to create a 3D scene model according to the image captured by the camera and the distance between the camera and any object in the field of view of the camera;
a detecting module operable to determine whether a target person appears in the created 3D scene model according to stored 3D models of target persons;
a direction determining module operable to determine a target person minimum region in the obtained image to comprise the whole target person when the target person appears in the created 3D scene model, generate an actual minimum region according to the determined target person minimum region in the obtained image, and compare the size of the actual minimum region with the size of a stored minimum region sample to determine the moving direction of the target person; and
an executing module operable to control a driving unit to drive the luggage case to move toward the moving direction determined by the direction determining module.

2. The luggage case as described in claim 1, further comprising a setting module, wherein the setting module is operable to obtain a sample of the target person image captured by the camera in response to an operation on an input unit, determine a target person minimum region in the sample of the target person image to comprise the whole target person, generate a minimum region sample according to the determined target person minimum region in the sample of the target person image, and store the sample of the target person image which comprises the minimum region sample in the storage unit, the size of the minimum region sample being capable of indicate the relationship of the distance between the luggage case and the target person.

3. The luggage case as described in claim 1, wherein the direction determining module is further to:
determine that the moving direction of the target person relation to the luggage case is forward when the size of the actual minimum region is less than the size of the minimum region sample;
determine that the target person relation to the luggage case is still when the size of the actual minimum region is equal to the size of the minimum region sample; and
determine that the moving direction of the target person relation to the luggage case is backward when the size of the actual minimum region is greater than the size of the minimum region sample.

4. The luggage case as described in claim 2, further comprising an angle determining module, wherein the angle determining module is operable to determine a center of the actual minimum region when the target person appears in the created 3D scene model, compare the determined center of the actual minimum region with a stored center of the minimum region sample when the difference between a first distance and a second distance is in a preset range, to determine a rotation direction and a rotation angle according to a stored ratio of the image size of the object in the image captured by the camera to the real-life size of the object when the distance between the object and the camera is a preset value, a first distance being the distance between the camera and the determined center of the actual minimum region, a second distance being the distance between the camera and the determined center of the minimum region sample; the executing module is further operable to drive the driving unit to rotate toward the determined rotation direction and rotate with the determined angle.

5. The luggage case as described in claim 4, wherein the setting module is further operable to determine a center of the minimum region sample and store the sample of target person image comprising the determined center of the minimum region sample in the storage unit, the position of the center of the minimum region sample being capable of indicating the relationship of the position between the luggage case and the target person.

6. The luggage case as described in claim 4, wherein the angle determining module in detail is operable to:
align the sample of the target person image and the obtained image when the difference between the first distance and the second distance is in a preset range, and consider the determined center of the actual minimum region and the determined center of the minimum region sample being in a same image;
establish a two-dimensional Cartesian coordinate system in the image, and determine a set of coordinates of the center of the actual minimum region and a set of coordinates of the center of the minimum region sample in the same image to determine the virtual distance in the image between the center of the actual minimum region and the center of the minimum region sample;
determine the actual distance between the center of the actual minimum region and the center of the minimum region sample according to the stored ratio of the image size of the object in the image captured by the camera to the real-life size of the actual object and the determined virtual distance in the image; a first side formed by the center of the actual minimum region and the center of the minimum region sample, a second side formed by the center of the actual minimum region and the camera, and a third side formed by the center of the minimum region sample being all connected to form a triangle; and
determine the rotation direction and the rotation angle of the luggage case according to the formula: cos θ=(a²+b²−c²)/2ab, wherein a represents the actual distance between the center of the actual minimum region and the center of the minimum region sample, b represents the distance between the center of the actual minimum region and the camera, and c represents the distance between the center of the minimum region sample and the camera.

7. The luggage case as described in claim 1, further comprising a speed determining module, wherein:
the image obtaining module is further operable to obtain a preset number of successive images captured by the camera every a preset time period;
the model creating module is further operable to create successive 3D scene models according to the preset number of successive images captured by the camera, and the distance between the camera and any object in the field of view of the camera;
the detecting module is further operable to determine whether the target person appears in the created successive 3D scene models;
the speed determining module is operable to select any two created 3D scene models from the created successive 3D scene models, determine the shortest distance between the camera and the target person comprised in each of the two selected 3D scene models, and determine that the moved distance by the target person relation to the luggage case in the two selected 3D scene model is the value of the difference of the two determined shortest distances between the camera and the target person comprised in each of the two created 3D scene models;
the speed determining module is operable to determine the number of 3D scene models between the two selected 3D scene models, divide a stored shooting speed of the camera from the determined number of 3D scene models to determine a moving time passing while the target person moves the determined moved distance by the target person relation to the luggage case, and further determine the moving direction and moving speed of the target person relation to the luggage case;
the speed determining module is operable to determine the moving speed of the luggage case according to the moving direction and the moving speed of the target person relation to the luggage case, and a stored default moving speed of the luggage case; and
the executing module is further operable to control the driving unit to drive the luggage case to move with the determined moving speed of the luggage case.

8. A luggage case moving method comprising:
obtaining an image captured by a camera, the image comprising a distance information indicating distances between the camera and objects captured by the camera;
creating a 3D scene model according to the image captured by the camera and the distance between the camera and any object in the field of view of the camera;
determining whether a target person appears in the created 3D scene model according to stored 3D models of target persons;
determining a target person minimum region in the obtained image to comprise the whole target person when the target person appears in the created 3D scene model, generate an actual minimum region according to the determined target person minimum region in the obtained image, and comparing the size of the actual minimum region with the size of a stored minimum region sample to determine the moving direction of the target person; and
controlling a driving unit to drive the luggage case to move toward the determined moving direction.

9. The luggage case moving method as described in claim 8, further comprising: obtaining a sample of the target person image captured by the camera in response to an operation on an input unit, determining a target person minimum region in the sample of the target person to comprise the whole target person, generate a minimum region sample according to the determined target person minimum region in the sample of the target person, and storing the sample of the target person image comprising the minimum region sample in a storage unit, the size of the minimum region sample being capable of indicate the relationship of the distance between the luggage case and the target person.

10. The luggage case moving method as described in claim 8, wherein the step of “comparing the size of the actual minimum region with the size of a stored minimum region sample to determine the moving direction of the target person” comprises:
determining that the moving direction of the target person relation to the luggage case is forward when the size of the actual minimum region is less than the size of the minimum region sample;
determining that the target person relation to the luggage case is still when the size of the actual minimum region is equal to the size of the minimum region sample; and
determining that the moving direction of the target person relation to the luggage case is backward when the size of the actual minimum region is greater than the size of the minimum region sample.

11. The luggage case moving method as described in claim 9, further comprising:
determining a center of the actual minimum region when the target person appears in the created 3D scene model, comparing the determined center of the actual minimum region with a stored center of the minimum region sample when the difference between a first distance and a second distance is in a preset range, to determine a rotation direction and a rotation angle according to a stored ratio of the image size of the object in the image captured by the camera to the real-life size of the object when the distance between the object and the camera is a preset value, a first distance being the distance between the camera and the determined center of the actual minimum region, a second distance being the distance between the camera and the determined center of the minimum region sample; and
driving the driving unit to rotate toward the determined rotation direction and rotate with the determined angle.

12. The luggage case moving method as described in claim 11, further comprising:
determining a center of the minimum region sample and storing the sample of the target person image comprising the determined center of the minimum region sample in the storage unit, the position of the center of the minimum region sample being capable of indicating the relationship of the position between the luggage case and the target person.

13. The luggage case moving method as described in claim 11, wherein the step of determining a rotation direction and a rotation angle comprises:
aligning the sample of the target person image and the obtained image when the difference between the first distance and the second distance is in a preset range, and considering the determined center of the actual minimum region and the determined center of the minimum region sample being in a same image;
establishing a two-dimensional Cartesian coordinate system in the image, and determining a set of coordinates of the center of the actual minimum region and a set of coordinates of the center of the minimum region sample in the same image to determine the virtual distance in the image between the center of the actual minimum region and the center of the minimum region sample;
determining the actual distance between the center of the actual minimum region and the center of the minimum region sample according to the stored ratio of the image size of the object in the image captured by the camera to the real-life size of the actual object and the determined virtual distance in the image; a first side formed by the center of the actual minimum region and the center of the minimum region sample, a second side formed by the center of the actual minimum region and the camera, and a third side formed by the center of the minimum region sample being all connected to form a triangle; and
determining the rotation direction and the rotation angle of the luggage case according to the formula: cos θ=(a²+b²−c²)/2ab, wherein a represents the actual distance between the center of the actual minimum region and the center of the minimum region sample, b represents the distance between the center of the actual minimum region and the camera, and c represents the distance between the center of the minimum region sample and the camera.

14. The luggage case moving method as described in claim 8, further comprising:
obtaining a preset number of successive images captured by the camera every a preset time period;
creating successive 3D scene models according to the preset number of successive images captured by the camera, and the distance between the camera and any object in the field of view of the camera;
determining whether the target person appears in the created successive 3D scene models;
selecting any two created 3D scene models from the created successive 3D scene models, determining the shortest distance between the camera and the target person comprised in each of the two selected 3D scene models, and determining that the moved distance by the target person relation to the luggage case in the two selected 3D scene model is the value of the difference of the determined two shortest distances between the camera and the target person comprised in each of the two created 3D scene models;
determining the number of 3D scene models between the two selected 3D scene models, dividing a stored shooting speed of the camera from the determined number of 3D scene models to determine a moving time passing while the target person moves the determined moved distance by the target person relation to the luggage case, and further determining the moving direction and moving speed of the target person relation to the luggage case;
determining the moving speed of the luggage case according to the moving direction and the moving speed of the target person relation to the luggage case, and a stored default moving speed of the luggage case; and
controlling the driving unit to drive the luggage case to move with the determined moving speed of the luggage case.

15. A non-transitory storage medium storing a set of instructions, the set of instructions capable of being executed by a processor of a luggage case, cause the luggage case to perform a luggage case moving method, the method comprising:
obtaining an image captured by a camera, the image comprising a distance information indicating distances between the camera and objects captured by the camera;
creating a 3D scene model according to the image captured by the camera and the distance between the camera and any object in the field of view of the camera;
determining whether the target person appears in the created 3D scene model according to stored 3D models of target persons;
determining a target person minimum region in the obtained image to comprise the whole target person when the target person appears in the created 3D scene model, generating an actual minimum region according to the determined target person minimum region in the obtained image, and comparing the size of the actual minimum region with the size of a stored minimum region sample to determine the moving direction of the target person; and
controlling the driving unit to drive the luggage case to move toward the determined moving direction.

16. The non-transitory storage medium as described in claim 15, further comprising:
obtaining a sample of the target person image captured by the camera in response to an operation on an input unit, determining a target person minimum region in the sample of the target person to comprise the whole target person, generate a minimum region sample according to the determined target person minimum region in the sample of the target person, and storing the sample of the target person image comprising the minimum region sample in a storage unit, the size of the minimum region sample being capable of indicate the relationship of the distance between the luggage case and the target person.

17. The non-transitory storage medium as described in claim 15, wherein the step of “comparing the size of the actual minimum region with the size of a stored minimum region sample to determine the moving direction of the target person” comprises:
determining that the moving direction of the target person relation to the luggage case is forward when the size of the actual minimum region is less than the size of the minimum region sample;
determining that the target person relation to the luggage case is still when the size of the actual minimum region is equal to the size of the minimum region sample; and
determining that the moving direction of the target person relation to the luggage case is backward when the size of the actual minimum region is greater than the size of the minimum region sample.

18. The non-transitory storage medium as described in claim 16, further comprising:
determining a center of the actual minimum region when the target person appears in the created 3D scene model, comparing the determined center of the actual minimum region with a stored center of the minimum region sample when the difference between a first distance and a second distance is in a preset range, to determine a rotation direction and a rotation angle according to a stored ratio of the image size of the object in the image captured by the camera to the real-life size of the object when the distance between the object and the camera is a preset value, a first distance being the distance between the camera and the determined center of the actual minimum region, a second distance being the distance between the camera and the determined center of the minimum region sample; and
driving the driving unit to rotate toward the determined rotation direction and rotate with the determined angle.

19. The non-transitory storage medium as described in claim 18, wherein the step of determine a rotation direction and a rotation angle comprises:
aligning the sample of the target person image and the obtained image when the difference between the first distance and the second distance is in a preset range, and considering the determined center of the actual minimum region and the determined center of the minimum region sample being in a same image;
establishing a two-dimensional Cartesian coordinate system in the image, and determining a set of coordinates of the center of the actual minimum region and a set of coordinates of the center of the minimum region sample in the same image to determine the virtual distance in the image between the center of the actual minimum region and the center of the minimum region sample;
determining the actual distance between the center of the actual minimum region and the center of the minimum region sample according to the stored ratio of the image size of the object in the image captured by the camera to the real-life size of the actual object and the determined virtual distance in the image; a first side formed by the center of the actual minimum region and the center of the minimum region sample, a second side formed by the center of the actual minimum region and the camera, and a third side formed by the center of the minimum region sample being all connected to form a triangle; and
determining the rotation direction and the rotation angle of the luggage case according to the formula: cos θ=(a²+b²−c²)/2ab, wherein a represents the actual distance between the center of the actual minimum region and the center of the minimum region sample, b represents the distance between the center of the actual minimum region and the camera, and c represents the distance between the center of the minimum region sample and the camera.

20. The non-transitory storage medium as described in claim 15, further comprising:
obtaining a preset number of successive images captured by the camera every a preset time period;
creating successive 3D scene models according to the preset number of successive images captured by the camera, and the distances between the camera and any object in the field of view of the camera;
determining whether the target person appears in the created successive 3D scene models;
selecting any two created 3D scene models from the created successive 3D scene models, determining the shortest distance between the camera and the target person comprised in each of the two selected 3D scene models, and determining that the moved distance by the target person relation to the luggage case in the two selected 3D scene model is the value of the difference of the two determined shortest distances between the camera and the target person comprised in each of the two created 3D scene models;
determining the number of 3D scene models between the two selected 3D scene models, dividing a stored shooting speed of the camera from the determined number of 3D scene models to determine a moving time passing while the target person moves the determined moved distance by the target person relation to the luggage case, and further determining the moving direction and moving speed of the target person relation to the luggage case;
determining the moving speed of the luggage case according to the moving direction and the moving speed of the target person relation to the luggage case, and a stored default moving speed of the luggage case; and
controlling the driving unit to drive the luggage case to move with the determined moving speed of the luggage case.
